(19) United States
(12) Patent Application Publication
(10) Pub. No.: US 2004/0141605 A1
(43) Pub. Date: Jul. 22, 2004

(54) Method and system for automatic real-time meeting attendance tracking and reporting in a multi-user telephone conferencing environment

(75) Inventors: Yen-Fu Chen, Austin, TX (US); Nancy T. Sun, Austin, TX (US)

Correspondence Address: Darcell Walker, 8107 Carvel Lane, Houston, TX, 77036, US

(73) Assignee: INTERNATIONAL BUSINESS MACHINES CORPORATION, Armonk, NY

(21) Appl. No.: 10/346,246

(22) Filed: Jan. 16, 2003

(51) Int. Cl. H04M 3/42

(52) U.S. Cl. 379/202.01

(57) ABSTRACT

The present invention provides an automated method and system to arrange and conduct a telephone conference meeting without the need for an independent moderator to conduct the meeting. With the present invention, a conference call host can automatically set up the meeting configuration in advance of the meeting, monitor activities during the meeting including the attendance of participants in the meeting and receive a report at the conclusion of the meeting. In addition, the present invention provides the capability to signal the host when a participant has entered or left the meeting without interrupting the meeting. This notification will enable the host to know who is in attendance at any given time during the meeting. The present invention can also assign permissions to the participants that will limit or allow a participant to speak during the meeting. With this ability, the host can control the flow of the meeting.

### FIELD OF THE INVENTION

This invention relates to a method and system for monitoring the events of a teleconference meeting and in particular to a method and system automatic for tracking, controlling and reporting the events of a teleconference meeting in real-time.

### BACKGROUND OF THE INVENTION

In the 21^{St} century, companies are conducting more business in a mobile environment. In many organizations, employees, colleagues and managers are spread out across the United States and around the globe. Therefore, many meetings are being conducted over the telephone and computer networks such as the Internat using communications companies like telecom giants AT&T, MCI, Sprint and software such as Microsoft's NetMeeting® or IBM's e-Meeting.

A basic service offered by telecommunications companies is to provide a communications connection between at least two parties for a certain period of time. The process of providing this telecommunications service can be described conceptually as arranging a telecommunications meeting between the participants (i.e., a so-called “telemeeting” or “telephone conference”). Ever since the emergence of this telemeeting concept, a number of pertinent questions have been raised, such as: How is it possible for a communications network manager to (1) effectively manage a telemeeting involving numerous participants, (2) control participation in a telemeeting (e.g., should the meeting be open to anyone), (3) enable participants to join a telemeeting from any location, and (4) schedule a telemeeting in terms of both time and place? Inevitably, in a conventional heterogeneous communications environment, telemeeting participants will attempt to gain admittance to a session in a number of different ways. However, from a conference planning and management standpoint, conventional communication networks are unable to determine beforehand the number of participants and how and where individual participants will be attempting to gain admittance to such a telemeeting.

Teleconferencing is one basic service offered by conventional telecommunications companies whereby a limited number of participants can confer simultaneously with each other. However, the basic services now being offered typically do not offer any type of conference management support. In other words, the communication connections between the conference participants are made by the person who has asked for and initiated the telemeeting. Typically, the person initiating the meeting notifies each participant in turn, which requires prior knowledge of information about the participant.

The current technology allows an initiator/moderator such as a project manager to hold a conference call for a group such as a project team of twenty members. Before the call begins, each member receives a reminder notice with dial-in number, time and passcode. As a call is being conducted, when a participant signs in, the conference call is alerted with a beep or the project manager waits for all to sign in and take roll. In the former situation, the beep sound when a participant enters or leaves the conference is very disruptive. In this latter situation, it can be very time-consuming not only for the Initiator but also those attending the call.

Normally, when there is a telephone conference, it is necessary to go through a moderator or a telephone company such as AT&T. A moderator is an online telephone company representative. This representative moderates the call, which can include performing services such as tracking the list of participants calling into the meeting and giving permission to participants to speak during the meeting.

As shown in FIG. 1, a conventional conference call configuration incorporates an initiator or moderator that controls the conducting of the meeting. The conference host could perform the tasks of the moderator. The role of the moderator includes several tasks. One task is to monitor which participants from an initial list of invited participants has called into the meeting. This task is one of attendance checking. The moderator would inform the meeting host when a participant has called into the meeting or has left the meeting. Another task can be to grant speaking permissions to the participants during the meeting. In the performance of this task, the moderator could mute out lines of those participants that do not have the permission to speak and allow only certain participants to speak that have the speaking permission. The moderator could also generate statistics of the meeting at the conclusion of the meeting. However, with a moderator, the original conference host may have to spend extra time and incur additional monetary costs in order to coordinate the meeting with the moderator.

The AT&T long distance telephone network offers a teleconferencing service known as the “Alliance Dedicated Teleconferencing Service.” This service can connect conference call participants together on up to 56 telephone lines. These conference calls are set up and controlled by AT&T operators with access to an AT&T conference management system. However, a limitation of this service is that the teleconference has to be booked in advance, which requires personal assistance from an AT&T operator. In an attempt to improve on the Alliance service in this regard, U.S. Pat. No. 4,796,293 entitled “Enhanced Dedicated Teleconferencing System” discloses a service computer which is used as an intermediary between the Alliance system and a non-AT&T conference coordinator. Consequently, the conference coordinator has conference management capabilities similar to those of an AT&T operator.

Other similar ideas such as described in U.S. Pat. No. 6,343,313 titled “Computer conferencing system with real-time multipoint, multi-speed, multi-stream scalability” which is a conferencing system with computers that require a client and server, or U.S. Pat. No. 6,272,214 titled “Automatic control of participation in telemeetings” which disclosed “telemeetings is administered automatically under the control of a communications network's service node”. However, this invention differs because it doesn't require a server and a client, instead, it still uses the telephone technology but has an administrative interface (client or web) to control various aspects of telephone conferencing. At the same time, it can be controlled by the party who hosting the telephone conference, not by the communication network's service. The only thing the telephone service provider controls is option to configure the conference call based on the features available to the administrator/moderator, such as pricing, time slots, minimum conferencing time, etc. This information will be retrieved from the service provider's database or third party vendor software (entity providing the software) to avoid tracking on both ends and present accurate and up to date information.

Another teleconferencing system is disclosed in U.S. Pat. No. 5,369,694, which is entitled “Unattended Meet-Me-Conference Controlled By A Telephone Terminal.” Essentially, this patent discloses a method for automatically connecting teleconference participants who can register for the conference by calling a predetermined telephone number. A telephone terminal (capable of executing application software programs) provides certain teleconferencing management and control functions, and uses control signals to communicate with the telecommunications network and establish connections for all conference participants. The disclosed system employs a modified Integrated Services Digital Network (ISDN) protocol to control the transfer of signaling and speech data. However, a problem with such a system is that special “intelligent” terminal equipment is required, which can limit the ultimate use of the service provided. Also, the use of an ISDN protocol can be technically and/or financially prohibitive for certain network operators. Furthermore, in order to obtain a global level of service with conventional methods, the necessary ISDN protocol would be required in all networks through which conference participants connect to a conference. An important advantage of the present invention is its independence from such restrictions.

Another disadvantage of the conventional conferencing methods is that only one mode of participation can be used based on a telephone connection. Consequently, in order to participate in a conference, there must be a telecommunications network available which excludes participation through, for example, a data network. The present invention advantageously allows a mixture of modes including participation through, for example, the Internet.

The current telephone services available for conference calls are not efficient for all involved. The problem arises because participants login at different times. Though meeting notices are sent out early and participants are recommended to be on time, it is still merely impractical and unfeasible to require everyone to be at a meeting at an exact time in today's dynamic business world or pose restrictions not allowing others to dial in after the meeting has started. These limitations simply will not work for many attendees for reasons like meeting overlaps, time zone issues, or people joining the conference call from different locations in the world.

The result of hosting a meeting with a diverse group of participants is the initiator/moderator ends up spending an excessive amount of time taking attendance instead of focusing on the discussion. The telephone conference is continuously interrupted as other participant joins or leaves the conference call, typically makes a beeping noise that interrupts the discussion and disturbs the meeting.

The original goal of holding conference calls is to conduct business matters in an effective and efficient manner. With the current technology available, excessive time is spent on taking attendance or as each person logs into the call, the meeting gets interrupted. Therefore, it is a market need for a method and system solution that can address the issues associated with the inefficient use of teleconferencing. A proper solution could limit teleconferencing cost issues through the effective use of teleconferencing.

### SUMMARY OF THE INVENTION

It is an objective of the present invention to provide an automated system for monitoring, tracking, controlling and reporting the events of a telephone conference meeting.

It is a second objective of the present invention to provide a method and system that will allow participants to call into a telephone conference meeting without interrupting the meeting.

It is a third objective of the present invention to provide a method and system to tracking the length of time a participant has attended the meeting.

It is a fourth objective of the present invention to provide method and system to control participation in the meeting by the participants.

It is fifth objective of the present invention to provide a method and system that will generate a report of the activities of the meeting at the conclusion of the meeting.

It is a sixth objective of the present invention to provide a method and system that can reduce the cost of a telephone conference by eliminating the need to organize the telephone conference through telephone companies.

It is a seventh objective of the present invention to provide a method and system to efficiently schedule a teleconference.

It is an eighth objective of the present invention to provide a method and system that will enable a company to connect to the Lightweight Directory Access Protocol (LDAP).

It is a ninth objective of the present invention to provide a method and system to reduce teleconference costs related to charges for reserved but unused resources.

The present invention provides an automated method and system to arrange and conduct a telephone conference meeting without the need for an independent moderator or anyone else (such as the meeting host) to conduct the meeting. With the present invention, a conference call host can automatically set up the meeting configuration in advance of the meeting, monitor the attendance of participants in the meeting and receive a report at the conclusion of the meeting. The present invention can establish a list identification numbers for persons that are to attend/participate in the meeting. The invention can then assign these numbers to the list of participants and send out notices to each of the meeting. The notice would contain information about the meeting and the participant's identification number. In addition, the present invention provides the capability to signal the host when a participant has entered or left the meeting. This notification will enable the host to know who is in attendance at any given time during the meeting. The present invention can also assign permissions to the participants that will limit or allow a participant to speak during the meeting. With this ability, the host can control the flow of the meeting.

The system of the present invention will allow a host machine to communicate with a telephone company providing the telephone conference service. This invention will allow the Initiator track attendance to the conference call without interruption from participants.

This present invention offers more control and more configuration options to automates almost all of the steps for a telephone conference. From setting up, emailing the invitation list, tracking responses, monitoring attendances, to reporting attendance results, this invention will automate the telephone conferencing processes and increase productive while reducing cost and decrease interferences by empowering administrator/moderator with functionalities and options included in this invention.

The present invention eliminates interruptions during the meeting, when a participate logs in to the meeting or logs out of the meeting. The present invention also tracks the callers in the meeting and the time. The present invention enables the meeting host to have the powers that belonged to the moderator. In a conventional conference meeting, the host of the meeting would connect their computer to the telephone and dial into the same number as the other the participants would dial into for the meeting. In the present invention, a computer detects the different participants dialing into the meeting through PIN or ID numbers. There would be a verification as to whether this person is invited to attend the meeting. With the PIN identification, when a participants dials into the meeting, the host will be informed that the participant has dialed into the meeting. The host can also mute the lines of various participants, and can also start the meeting after a certain number of persons or certain key people have dialed into the meeting. Currently, most of the above-described tasks are performed by the telephone moderator (telecom carrier). After the meeting, there can be statistics generated about the meeting such as the number of persons on the call.

This approach of the present invention enables companies to only pay for the resources that they actually used during the meeting. These resources can include the number of lines needed for the meeting and the amount of time required (usage) for the meeting. This service also enables one to pick different levels of service.

### DESCRIPTION OF THE DRAWINGS

FIG. 1 is a configuration for a conventional telephone conference meeting where there is an interruption when a participant signs into the meeting.

FIG. 2 is a configuration for a telephone conference meeting using the method and system of the present invention with no interruption when a participant signs into the meeting.

FIG. 3 is a flow diagram of the main steps in the implementation of the method of the present invention.

FIG. 4 is a flow diagram for configuring the telephone conference call prior to the meeting.

FIG. 5 is a flow diagram for contacting meeting participants with information about the meeting.

FIG. 6 is a flow diagram in which the present invention monitors the meeting for events and determines the type of action to take based on the event.

FIG. 7 is a flow diagram for granting access to the meeting to a contacted participant.

FIG. 8 is a flow diagram for monitoring the activities of the meeting and responding to an event occurring during the meeting.

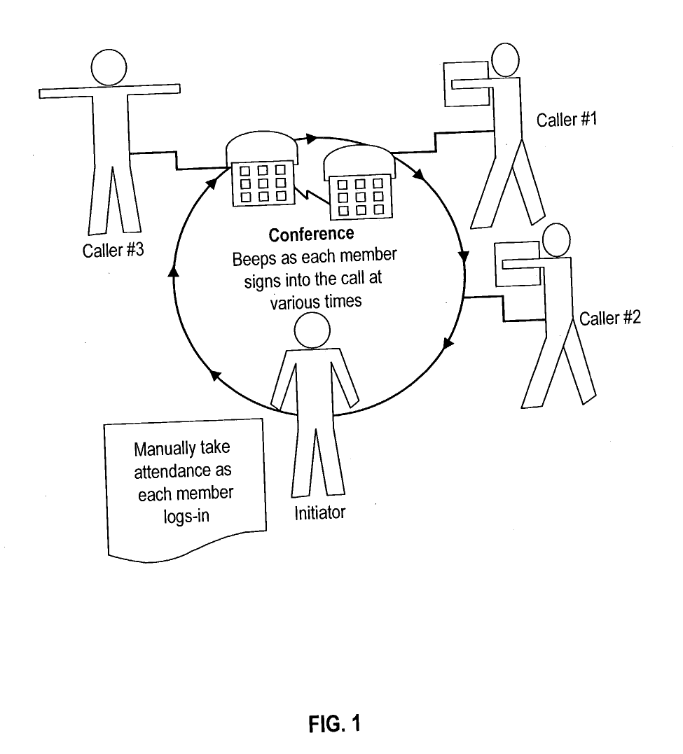

### DETAILED DESCRIPTION OF THE INVENTION

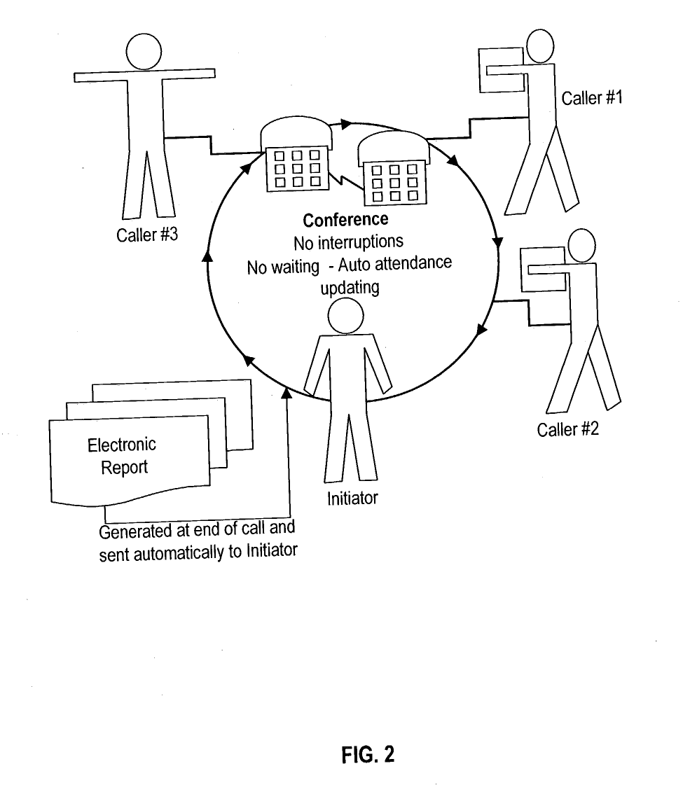

The present invention provides an improved method and system for conducting telephone conference meetings. This invention allows for the automatic monitoring, tracking and recording of meeting data that was not previously collected or was done manually. As shown in FIG. 2, the method of the present invention can be implemented with software housed in the host computer or at the local telephone carrier. This software would perform tasks such as assigning identification numbers to meeting participants, monitoring participant access and departure times and permitting certain participants to speak during the meeting and generating a report of the activities of the meeting at the conclusion of the meeting. With this method, the meeting is not interrupted each time a participant enters or leaves the meeting. As shown in FIG. 2, the meeting initiator (also referred to as the host) connects to the other meeting participants via a specifically configured telephone connection at the telephone carrier location. The software at the carrier location controls the various activities of the meeting. At the completion of the meeting, a report is generated and sent to the meeting initiator.

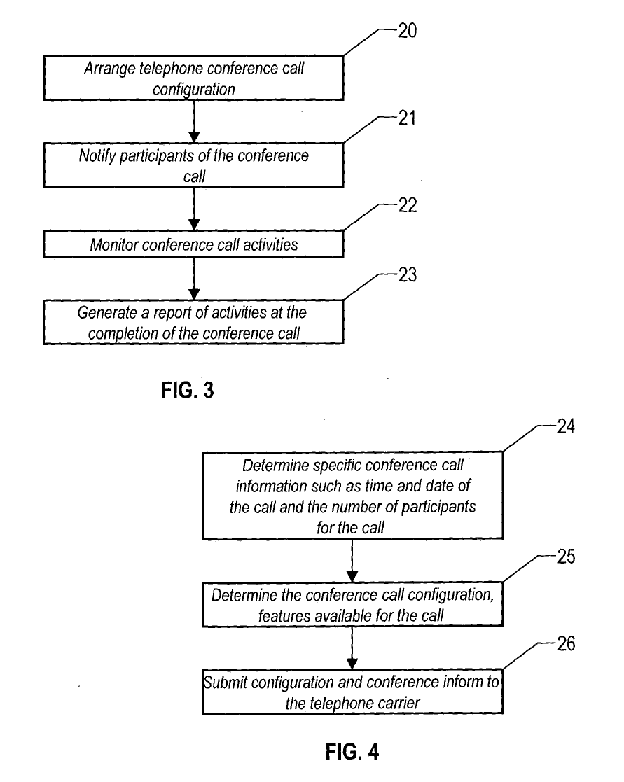

Referring to FIG. 3, there is a flow diagram of the main steps in the implementation of the method of the present invention. As shown in step 20, the initiator has an opportunity to configure the meeting in any manner that they choose. Telephone carriers provide several services that can be used during a telephone conference meeting such as the before mentioned access monitoring, automated attendance tacking and updating, speaking permissions, and final report generation. These features are the basic one discussed in the context of this invention, but there are also other features made available by the telephone carriers that the initiator can select for their particular meeting.

With this feature, individual participants could have the opportunity to speak during the conference or could be in a mute mode depending on authorizations and control options assigned by the conference chairperson. In this mode, only the speakers' phone line would be activated so not only would the voice of the participant be muted, but any background noise generated at the location of the participant would be eliminated as well. Because speaker may change during the phone conference, this feature will handle the automatic activation and deactivation of phone lines as speaker exchange occurs. Another feature can be an automatic redial capability. In the event that a participant becomes involuntarily disconnected, the participant could redial the conference number or attempt to access the conference and receive immediate access without going through participant verification procedures. For example, a participant that has used a cellular telephone to access a meeting has a strong possibility of losing the connection. When the loss connection occurs, the participant may have a set time amount of time to redial the conference and have immediate access. As part of the process to enable a disconnected to party to reconnect, there could be a certain procedure to follow when voluntarily disconnecting that will enable a program to know if the disconnect was voluntary. The participant may need to press a certain key and hang-up to indicate a voluntary disconnect. If the program detects involuntary disconnects, the participant could be automatically redialed.

Another option would be to use a computer as the accessing device instead of a telephone. In this case, a computer (hardware device) with a unique identification could access the conference. This application could be similar to other applications where a specific computer is identified with a specific participant. This computer could also have options that could remind the participant of the meeting at a designated time prior to the meeting where a button or link on the reminder can be clicked and the joining of teleconference process is automatically carried out: Phone linked to the computer would be dialed to join the teleconference and access granted based on the password used for the computer.

Another option for someone using a computer to access the meeting is the ability to participate in the conference via typing in questions or comments to the conference. If a participant was unable to verbally participate, the typed questions could be verbalized in the conference through voice translation software for the other participants to hear.

The next step following the conference configuration is to inform the participants to the conference call meeting in step 21. This step could be implemented by sending out electronic mail notices to the participants. The third general step is to monitor that actual telephone conference meeting in step 22. During the meeting, the method of the present invention will perform the tasks identified by the initiator in step 20. At the completion of the meeting, step 23 generates a final report and sends it to the initiator. This report contains information such as the number of participants that accessed the meeting, the time each participant accessed the meeting and the length of time each participant attended the meeting. From this information, it can be determined the number of telephone lines that were used during the meeting and the length of use of each line. This information can be important when negotiating costs for services with the telephone carrier.

FIG. 4 is a flow diagram of the steps involved in the configuration of the telephone conference prior to the commencement of the actual meeting. Referring to FIG. 3, the configuration activity occurred in step 20. In FIG. 4, the initial step 24 is to determine the specific conference meeting information, which includes the date and time of the meeting. In addition, it is necessary to determine the number of participants that are expected to attend the meeting. The number of participants has a large affect on the configuration of the meeting. The number of participants can range from a few to hundreds, especially with large companies. The telephone carrier will also use this information to determine the number of telephone lines that will be necessary for this meeting. In step 25, the initiator will determine the features that will be used to monitor, control and track the activities of the meeting. The initiator will typically consult with a representative of the telephone carrier to make these decisions. In step 26, the information collected in step 25 is sent to the telephone carrier for processing and creating of the desired conference configuration.

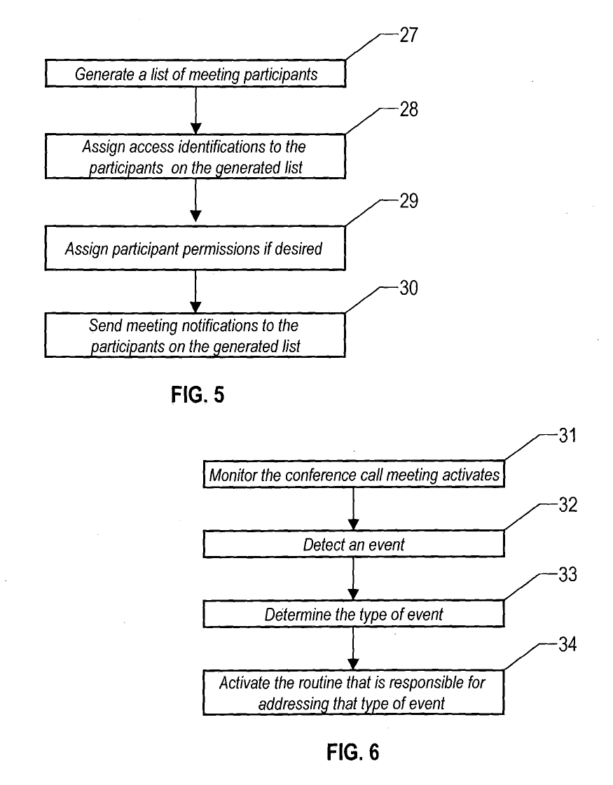

FIG. 5 illustrates the steps involved in notifying participants about the upcoming meeting, which is step 21 shown in FIG. 3. In step 27, the initiator generates a list of participants that they want to attend the meeting. After generating this list, in step 28 access identifications can be assigned to each participant on the list. The present invention enables each participant to have a unique personal identification number (PIN). In one implementation example, this PIN can be attached to the end of any passcode or entered upon prompt. However, during the meeting, a participant identification can only be used by one participant. A second participant cannot access the meeting using an identification currently used by someone already having access to the meeting. During the sign-in process, one team member signs-in, an attendance sheet is generated or compared, for the conference initiator or host. This report can be updated live during the call so that project manager will have up-to-date information as he/she discusses business matters at hand. At the same time, the initiator can grant the rights of viewing the attendance list to the people with the need-to-know basis, so not everyone has to be informed with the list and know the join/leave status of the attendees.

In addition to assigning an identification number to the notified participants, step 29 provides the assigning of permissions to the participants. The meeting initiator may have priority of participants that are allowed to speak during the meeting and other participants that are observers. This permissions feature will also help control order during the meeting. After assembling the participant list, access identification list and the permissions list if desired, step 30 sends the information to the central software at the telephone carrier. Each participant receives a meeting notification with his or her particular access identification for the meeting. In another sequence, since not all notified participants may attend the meeting, the information to be sent to the telephone carrier related to the participants can wait until confirmation from a participant that they will attend the meeting.

The real advantage of the present invention is realized at the commencement of the meeting. In FIG. 6, step 31 at the scheduled time of the meeting the process of the present invention will go into monitor mode. The process is waiting for any activity to occur on the telephone lines that have been reserved for this during the configuration procedure illustrated in FIG. 4. The main activities typically are participants attempting access the meeting, participants leaving the meeting and controlling the conversation during the meeting based on the assigned permissions. If an event is detected in step 32, the next step is to determine the type of event in step 33 and route the event to the proper procedure to address that event in step 34.

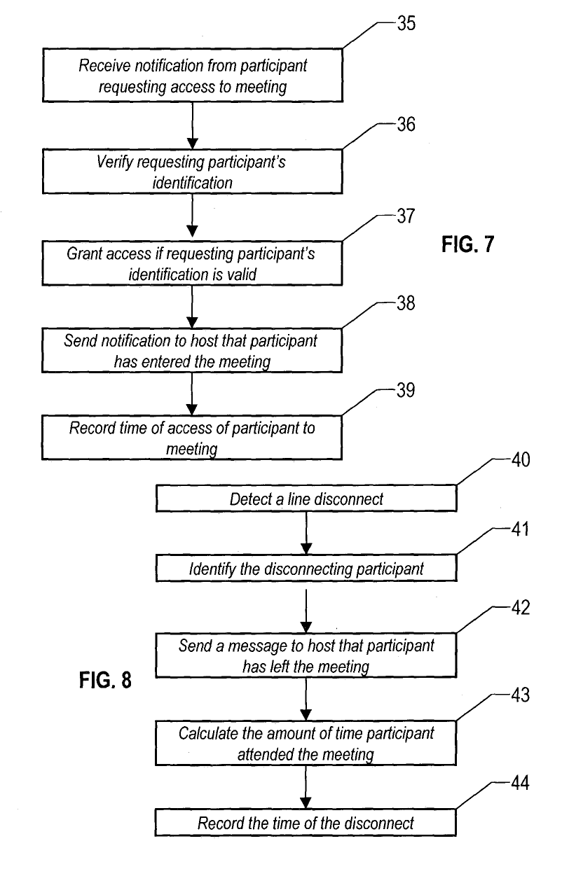

FIG. 7 illustrates the steps that occur when the detected event is an attempt by a participant to access the meeting. When a participant dials the number for the meeting, the event is detected, determined to be an access request and routed to this routine. The routine will receive an access notification in step 35 from that a participant desires to enter the meeting. Step 36 will verify the identification of the participant making the access request. This verification can by requesting the participant's identification and comparing this identification with the identification originally assigned to that particular participant in step 28 shown in FIG. 5. If there is match between the participant name and the participant identification there will a validation of the participant identification and the participant will receive access to the meeting in step 37. At this point, in step 38, the initiator will receive notification that the participant is in the meeting. Step 39 will record the time that this participant entered the meeting. Based on whether this participant has speaking permissions, the participant's telephone line may be muted to prevent the participant from speaking. This muting operation will occur if the participant does not have speaking permissions. The initiator will have a current list of the participants that have entered the meeting. The initiator has the power to begin the meeting whenever they desire. This desire could be based on whether certain participants have entered the meeting.

Another event that is monitored is when a participant leaves the meeting. When a line disconnects it is detected, step 40, and the participant for that line is identified step 41. In step 42, the initiator receives a message that the participant has left the meeting. The amount of time that participant was in the meeting is calculated step 43. The time that the participant was connected to the meeting is then recorded and maintained in step 44. This information will be used in the generation of the final report.

As mentioned, each event during the meeting is recorded and at the completion of the meeting certain statistical information is generated that characterize the activities of the meeting. This type of information can be valuable when planning future meetings and in negotiations with telephone carriers concerns billing for actual use of carrier resources. In addition, as each person participates at different times, the meeting itself is not interrupted by any noise, beep or prolong waiting for others. At the end of the meeting, an electronic report is generated to the Initiator with attendees' names, and time of login, time of sign-off and total duration of time. This information will help the project manager in managing time effectively, but also run the meeting in a more efficient manner while reducing cost for the company.

The features of the present invention provide considerable advantages over conventional teleconferencing systems. Some of these advantages are described as follows:

1) This invention can be implemented using an application (client or web) where administrative can configured setting for moderating the meeting, tracking the attendance, and generate reporting.

2) The administrator of this utility can assign rights to anyone who joins the conference.

3) If the telephone conference is organized through telephone companies such as AT&T, MCI, or Sprint, businesses can reduce cost by eliminating the need of an operator. Instead, moderator/initiator of the meeting is able to control the meeting using this invention via computer (client GUI, web site) or telephone. As a result, businesses may be motivated to use the telephone companies to organize the conference because the business (telephone company customer) has more control over the conference

4) Real-time updates of meeting attendance: As soon as a person enters the conference number and their PIN, this invention will automatically updates add the person's PIN to the attendance list, which can be viewed by the conference host, chairperson and/or conference moderator. This invention can be integrated with a company's Lightweight Directory Access Protocol (LDAP) like IBM's bluepages or the PIN's can be mapped using this inventions control to have individual profile information so more detail information can be displayed instead of just the PIN. The PIN can even be mapped to the incoming telephone number. The purpose of a PIN is a way of identifying the caller joining the conference. The method of displaying profile can certainly be configured to just display specific fields such as the PIN, Lastname+Firstname, or any combination of the data or information in the LDAP, and more detailed information can be setup for display when certain events occurs; such as when PIN is clicked on or when there is a ‘mouse over’ over the PIN.

5) This invention will automatically generate a report for the administrator (operator and/or initiator). This invention can be configured to sent a report to specified email addresses and/or automatically post to the administration web site for viewing.

6) This invention's tracking system can decipher the incoming caller's information and report are code, location of the caller, etc.

7) Built-In invitation management utility such as invitation function in IBM's Notes' Calendar.

8) Integrated to telephone service providers middleware (charging systems) so if a customer like IBM wants to setup a telephone conference, IBM can select a list of telephone conference providers from this invention's administrative tool, view requirements/rates/options, and enter the required information. Instead of calling MCI and setup the conference call through an operator or having to go to the provider's web site, this invention can be an all-in-one tool for telephone conference.

9) Plug-Ins available for integration of this invention into common meeting and invitation system such as Lotus Notes, Microsoft Outlook, and e-Invite will enable tracking at multiple levels:

Before the meeting—Utilizing the invitation list to generate and send PINs for all attendees or only attendee who accepted the invitation so attendees will receive their PIN along with the invitation in the same notification. Company can also use their employees' existing information in their internal database such as serial number or contact identity to map to the generated PINs to be tracked using the invention. This can also help track the invitation responses so this invention can generate a report of who accepted the invitation but did not join the meeting.

During the meeting—Enables the moderator/initiator to obtain information stored in the invitation list such as contact information.

After the meeting—Utilizing the invitation list to send reports and limit access to the list of people predefined by an administrator.

10) Can be integrated into a recording system where all the conversation during the conference are recorded, at the same time, based on the PIN, individual voice inputs can be retrieved.

11) Reduction in both the time people spend on taking attendance and the number of interruptions as each person logs into a conference call.

12) Silent attendance tracking is valuable in today's dynamic business world so everyone in the telephone conference can maintain their concentration during the meeting and continue meeting discussions without interruptions.

13) This invention avoids unnecessary disturbances to telephone conferences and maximizing productivity by eliminating beeping noise, taking rolls, tracking participation time, monitoring attendances and reporting.

The system of the present invention can comprise the telephone lines and switching equipment located at the telephone carrier. Another component of the system would be the computer/machine at the location of the teleconference host. The software which would be used in this system and a core component of the invention can be housed at both the telephone switching station and the host computer location. The software located at the switching station would control the lines used for the teleconference. As part of controlling the telephone lines, this software would monitor the lines, verify and grant access to the participants, record any event or activity during the meeting and generate a final report based on the accumulated data gathered and recorded during the meeting. The software at the host would compile information initially to configure the conference call and send this information to the telephone carrier switching location and conference chairperson or host location.

In another embodiment, the controlling software could be located at any location as long as there are means to connect with the telephone carriers switching equipment. A server in a third location could control the access to the telephone lines conference call via connection through a communication network an use conventional remote control techniques to control the telephone equipment.

The market size for this invention is quite large. All companies despite its size conducts conference calls in its daily business transactions, especially for large companies, this invention is both a cost-saving and time saving tool.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

Having thus described the invention, what we claims as new and desire to secure by Letters Patent is set forth in the following claims.

We claim:

1. A method for tracking activities of a teleconference meeting in real-time comprising the steps of:
creating a telephone conference meeting configuration;
notifying telephone conference meeting participants of the meeting;
monitoring the activities occurring during the teleconference meeting; and
generating a report of the activities that occurred during the telephone meeting at the end of the conference.

2. The method as described in claim 1 wherein said configuration creation step further comprises the steps of:
determining the specific telephone meeting information;
determining the features that will be implemented during the telephone meeting to monitor and conduct the meeting; and
submitting the telephone meeting information and features information to the telephone carrier that will be used during the meeting.

3. The method as described in claim 2 wherein the telephone meeting information comprises the time of the meeting, the date of the meeting and the number of participants attending the meeting.

4. The method as described in claim 1 wherein said participant notifying step further comprises the steps of:
generating a list of meeting participants that will be invited to attend the telephone meeting;
assigning identifications to each participant on the generated list;
sending meeting information including the date and time of the meeting to each participant about the meeting.

5. The method as described in claim 4 wherein the assigned participant identifications are not submitted to each participant with the meeting information.

6. The method as described in claim 5 wherein the assigned participant identifications are submitted to each participant at the request of the participant after the participant receives the notification.

7. The method as described in claim 4 further comprising the steps of:
generating a set of permissions for the participants on the list;
assigning the permissions as desired to the designated participants; and
sending the permission information to the designated participants.

8. The method as described in claim 1 wherein said monitoring step further comprises the steps of:
monitoring the telephone lines used during the meeting;
detecting an event on a telephone line;
determining the type of detected event; and
activating the routine that addresses the particular type of event the was detected.

9. The method as described in claim 8 wherein the routine for addressing an event in which a participant requests access to telephone meeting comprises the steps of:
receiving notification from the participant requesting access to the meeting;
verifying the requesting participant's identification;
granting access to the meeting when the participant's identification is valid;
sending a notification to the host of the meeting that the participant has entered the meeting; and
recording the time that the participant entered the meeting.

10. The method as described in claim 9 wherein said participant identification verification comprises the steps of:
receiving the participant's name and identification number;
matching the participant's identification number with the number on the participant list;
matching the participant's name with the name on the list, when there is an identification number match; and
granting access when there is a match of both the name and identification number of the participant with the participant name and number on the initial generated list.

11. The method as described in claim 8 wherein the routine for addressing an event in which a participant leaves the telephone meeting comprises the steps of:
detecting a disconnected telephone line;
sending a message to the host that the participant has left the meeting; and
recording the time of the participant disconnect.

12. A computer program product in a computer readable medium for use in tracking activities of a teleconference meeting in real-time comprising:
instructions for creating a telephone conference meeting configuration;
instructions for notifying telephone conference meeting participants of the meeting;
instructions for monitoring the activities occurring during the teleconference meeting; and
instructions for generating a report of the activities that occurred during the telephone meeting at the end of the conference.

13. The computer program product as described in claim 12 wherein said configuration creation instructions further comprise:
instructions for determining the specific telephone meeting information;
instructions for determining the features that will be implemented during the telephone meeting to monitor and conduct the meeting; and
instructions for submitting the telephone meeting information and features information to the telephone carrier that will be used during the meeting.

14. The computer program product as described in claim 12 wherein said participant notifying instruction further comprise instructions for:
generating a list of meeting participants that will be invited to attend the telephone meeting;
assigning identifications to each participant on the generated list;
sending meeting information including the date and time of the meeting to each participant about the meeting.

15. The computer program product as described in claim 14 further comprising instructions for requesting a participant after the participant receives the meeting notification.

16. The computer program product as described in claim 14 further comprising:
instructions for generating a set of permissions for the participants on the list;
instructions for assigning the permissions as desired to the designated participants; and
instructions for sending the permission information to the designated participants.

17. The computer program product as described in claim 12 wherein said monitoring instructions further comprise:
instructions for monitoring the telephone lines used during the meeting;
instructions for detecting an event on a telephone line;
instructions for determining the type of detected event; and
instructions for activating the routine that addresses the particular type of event the was detected.

18. The computer program product as described in claim 17 wherein the routine for addressing an event in which a participant requests access to telephone meeting comprises:
instructions for receiving notification from the participant requesting access to the meeting;
instructions for verifying the requesting participant's identification;
instructions for granting access to the meeting when the participant's identification is valid;
instructions for sending a notification to the host of the meeting that the participant has entered the meeting; and
instructions for recording the time that the participant entered the meeting.

19. The computer product program as described in claim 18 wherein said participant identification verification comprises:
instructions for receiving the participant's name and identification number;
instructions for matching the participant's identification number with the number on the participant list;
instructions for matching the participant's name with the name on the list, when there is an identification number match; and
instructions for granting access when there is a match of both the name and identification number of the participant with the participant name and number on the initial generated list.

20. The computer program product as described in claim 17 wherein the routine for addressing an event in which a participant leaves the telephone meeting comprises the steps of:
instructions for detecting a disconnected telephone line;
instructions for sending a message to the host that the participant has left the meeting; and
instructions for recording the time of the participant disconnect.

21. A system for tracking activities of a teleconference meeting in real-time comprising:
a host machine for inputting teleconference meeting information to a telephone carrier location;
a processing program for connecting to the telephone carrier location and for processing the teleconference meeting information prior to inputting the information to the telephone location;
a telephone carrier location, said carrier location containing a plurality of telephone lines used in a teleconference meeting; and
a telephone carrier processing program located the telephone carrier location for receiving teleconference meeting information from the host machine, said telephone carrier processing program having the capability to monitor activity on the telephone lines during a teleconference meeting, and generate a report of the activities at the completion of the teleconference meeting.

22. The system as described in claim 21 wherein said telephone carrier program further comprises the capability to control access to the teleconference meeting by participants.

23. The system as described in claim 20 further comprising a software program that identifies a specific hardware machine with a specific teleconference participant for purposes of accessing a teleconference via the hardware machine.

24. The system as described in claim 23 wherein a participant can communicate with other participants during a teleconference by typing or transmitting information through the hardware machine.

25. The system as described in claim 20 further comprising a software program that enables a conference participant to automatically reconnect to the conference following a disconnection.

26. The system as described in claim 20 further comprising a software program that automatically reminds a participant of a meeting at a point prior to the beginning of the meeting and enabling participants accessing a teleconference via the hardware machine from a single click on the reminder.
